(19) United States
(12) Patent Application Publication
(10) Pub. No.: US 2011/0038100 A1
(43) Pub. Date: Feb. 17, 2011

(54) Porous Carbon Oxide Nanocomposite Electrodes for High Energy Density Supercapacitors

(76) Inventors: Chun Lu, Sewickley, PA (US); Kevin Huang, Export, PA (US); Rosewell J. Ruka, Pittsburgh, PA (US)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 12/695,405

(22) Filed: Jan. 28, 2010

Related U.S. Application Data
(60) Provisional application No. 61/232,831, filed on Aug. 11, 2009.

(51) Int. Cl. H01G 9/058

(52) U.S. Cl. 361/502; 977/948

(57) ABSTRACT

A high energy density supercapacitor is provided by using nanocomposite electrodes having an electrically conductive carbon network having a surface area greater than 2,000 m²/g and a pseudo-capacitive metal oxide such as MnO₂. The conductive carbon network is incorporated into a porous metal oxide structure to introduce sufficient electricity conductivity so that the bulk of metal oxide is utilized for charge storage, and/or the surface of the conductive carbon network is decorated with metal oxide to increase the surface area and amount of pseudo-capacitive metal oxide in the nanocomposite electrode for charge storage.

### CROSS REFERENCE TO RELATED APPLICATION

This application claims priority under 35 U.S.C. §119(e) to U.S. Provisional Patent Application Ser. No. 61/232,831, filed Aug. 11, 2009 entitled, POROUS GRAPHENE OXIDE NANOCOMPOSITE ELECTRODES FOR HIGH ENERGY DENSITY SUPERCAPACITORS.

### BACKGROUND OF THE INVENTION

1. Field of the Invention

The present invention relates to carbon-oxide nanocomposite electrodes for a supercapacitor having both high power density and high energy density.

2. Description of Related Art

During the past two decades, the demand for the storage of electrical energy has increased significantly in the areas of portable, transportation, and load-leveling and central backup applications. The present electrochemical energy storage systems are simply too costly to penetrate major new markets. Still higher performance is required, and environmentally acceptable materials are preferred. Transformational changes in electrical energy storage science and technology are in great demand to allow higher and faster energy storage at the lower cost and longer lifetime necessary for major market enlargement. Most of these changes require new materials and/or innovative concepts with demonstration of larger redox capacities that react more rapidly and reversibly with cations and/or anions.

Batteries are by far the most common form of storing electrical energy, ranging from the standard every day lead—acid cells to exotic iron-silver batteries for nuclear submarines taught by Brown in U.S. Pat. No. 4,078,125, to nickel-metal hydride (NiMH) batteries taught by Kitayama in U.S. Pat. No. 6,399,247 B1, to metal-air cells taught in U.S. Pat. No. 3,977,901 (Buzzelli) and Isenberg in U.S. Pat. No. 4,054,729 and to the lithium-ion battery taught by Ohata in U.S. Pat. No. 7,396,612 B2. These latter metal-air, nickel-metal hydride and lithium-ion battery cells require liquid electrolyte systems.

Batteries range in size from button cells used in watches, to megawatt loading leveling applications. They are, in general, efficient storage devices, with output energy typically exceeding 90% of input energy, except at the highest power densities. Rechargeable batteries have evolved over the years from lead-acid through nickel-cadmium and nickel-metal hydride (NiMH) to lithium-ion. NiMH batteries were the initial workhorse for electronic devices such as computers and cell phones, but they have almost been completely displaced from that market by lithium-ion batteries because of the latter's higher energy storage capacity. Today, NiMH technology is the principal battery used in hybrid electric vehicles, but it is likely to be displaced by the higher power energy and now lower cost lithium batteries, if the latter's safety and lifetime can be improved. Of the advanced batteries, lithium-ion is the dominant power source for most rechargeable electronic devices.

Batteries, supercapacitors and to a lesser extent, fuel cells, are the primary electrochemical devices for energy storage. Because supercapacitors in general show high power density, long lifetime and fast response, they have played a vital role in energy storage field. One of the major limitations for supercapacitor for its prevalent application is its slower energy density when compared with fuel cell and battery. Therefore, increasing energy density of supercapacitors has been a focal point in scientific and industrial world.

FIG. 1 is a schematic illustration of present supercapacitors having porous electrodes. A porous electrode material 10 is deposited on an electrically conductive current collector 11, and its pores are filled with electrolyte 12. Two electrodes are assembled together and separated with a separator 13 generally made of ceramic and polymer having high dielectric constants. The factors determining energy density are set out in the equation:

E=CV²/2=εAV²/2d, where

E=energy density

C: capacitance

V: working voltage

ε: dielectric constant of separator

A: active surface area of electrode

d: thickness of electrical double layer.

Because the energy density of a supercapacitor is, in part, decided by the active surface area of its electrodes, high surface area materials including activated carbon have been employed in the electrodes. In addition, it was discovered that some oxides displayed pseudo-capacitive characteristic in such a way that the oxides store the charge by physical surface adsorption and chemical bulk absorption. Hence, the pseudo-capacitive oxides are actively pursued for supercapacitors. Unfortunately, the oxides show low electrical conductivity so that they must be supported by a conductive component such as activated carbon.

FIG. 2 shows a self-explanatory graph from the U.S. Defense Logistics Agency, illustrating prior art high energy density low power density fuel cells, lead-acid, NiCd batteries, mid range lithium batteries, double layer capacitors, top end high power density, low energy density supercapacitors, and aluminum electrolytic capacitors. FIG. 2 shows their relationship in terms of power density (w/kg) and energy density (Wh/kg).

Supercapacitors, shown as 14, are in a unique position of very high power density (W/kg) and moderate energy density (Wh/kg).

Supercapacitor electrodes containing a metal oxide and carbon-containing material can be made by adding active carbon to a precipitated metal hydroxide gel based on a metal salt, aqueous base, alcohol interaction as taught by U.S. Pat. No. 5,658,355 (Cottevieille et al.) in 1997. The whole is mixed into an electrode paste added with a binder. Later, Manthiram et al. in U.S. Pat. No. 6,331,282 B1 utilized manganese oxyiodide produced by reducing sodium permanganate by lithium iodide for battery and supercapacitor applications by mixing it with a conducting material such as carbon.

A set of patents, U.S. Pat. Nos. 6,339,528 B1 and 6,616,875 B1 (both Lee et al.) taught potassium permanganate absorption on carbon or activated carbon and mixing with manganese acetate solution to faun amorphous manganese oxide which is ground to a powder and mixed with a binder to provide an electrode having high capacitance suitable for a supercapacitor. U.S. Pat. No. 6,510,042 B1 (Lee et al.) teaches a metal oxide pseudocapacitor having a current collector containing a conductive material and an active material of metal oxide coated with conducting polymer on the current collector.

What is needed is a new and improved supercapacitor utilizing novel construction, having energy density as good as lead-acid, NiCd and lithium batteries and almost comparable to fuel cells while having power density comparable to aluminum-electrolytic capacitors, ambient temperature operation, rapid response and long cycle lifetime.

It is a main object of this invention to provide supercapacitors that supply the above needs.

### SUMMARY OF THE INVENTION

The above needs are supplied and object accomplished by providing an electrochemical storage device comprising a porous graphene-oxide nanocomposite electrode comprising 1) a porous electrically conductive graphene carbon network having a surface area greater than 2,000 m²/g, and 2) a coating of a pseudo-capacitive metal oxide, such as MnO₂ supported by the network, wherein the network and coating form a porous nanocomposite electrode, as schematically illustrated in FIG. 3. FIG. 3 shows an electronically conductive network 15 containing pseudo-capacitive oxide 16 and pores 17. In FIG. 4, these elements are shown as 15′, 16′ and 17′, respectively. The graphene carbon conductive network 15′ can be incorporated into pores of a pseudo-capacitive oxide skeleton 18, as schematically shown in FIG. 4. The surface of the graphene carbon conductive network 15′ can be coated with the same or different pseudo-capacitive oxides 16′. The formed composites are capable of storing energy both physically and chemically.

Graphene is a planar sheet 19 of carbon atoms 20 densely packed in a honeycomb crystal lattice, as later illustrated in FIG. 6, generally one carbon atom thick. It has an extremely high surface area of greater than 2,000 m²/g, preferably from about 2,000 m²/g to about 3,000 m²/g, usually 2,500 m²/g to 2,000 m²/g and conducts electricity better than silver. MnO₂ has a high capacitance due to additional bulk participation for energy storage (MnO₂+K⁺ (potassium ion)+e⁻=MnOOK). The graphine can be substituted for by activated carbon, amorphous carbon and carbon nanotube and the MnO₂ substituted for by NiO, RuO₂, SrO₂, SrRuO₃.

In this invention, newly designed nanocomposite electrodes allow employment of increasing amount of the pseudo-capacitive oxide by directly supporting the oxide with high surface area graphene carbon and/or coating, so that the graphene carbon is contained within or incorporated into (“decorated”) the pores of a pseudo-capacitive skeleton. Its surface area is further increased by coating the graphene carbon with the same or different pseudo-capacitive oxides. The term “nanocomposite electrode” herein is defined to mean that, at least, one of individual components has a particle size less than 100 nanometers (nm). The electrode porosity ranges from 30 vol. % to 65 vol. % porous. Preferably, two nanocomposite electrodes are disposed on either side of a separator and each electrode contacts an outside current collector. The term “decorated” “decorating” as used herein means coated/contained within or incorporated into.

### BRIEF DESCRIPTION OF THE DRAWINGS

For a better understanding of the invention, reference may be made to the preferred embodiments exemplary of this invention, shown in the accompanying drawings in which:

FIG. 1 is a prior art schematic illustration of a present supercapacitor having porous electrodes;

FIG. 2 is a graph from the U.S. Defense Logistics Agency illustrating energy density vs. power density for electrochemical devices ranging from fuel cells to lithium batteries to supercapacitors;

FIG. 3, which best shows the broad invention, is a schematic representation of one of the envisioned nanocomposites containing an electrically conductive network supporting pseudo-capacitive oxides;

FIG. 4 is a schematic representation of other envisioned nanocomposites containing a pseudo-capacitive oxide skeleton whose pores are incorporated with an electrically conductive network coated with pseudo-capacitive oxides;

FIG. 5 shows the projected performance of a high energy density (HED) supercapacitor having porous nanocomposite electrodes, compared with present technologies;

FIG. 6 illustrates an idealized planar sheet of one-atom-thick graphene where carbon atoms 20 are densely packed in a honeycomb crystal lattice;

FIGS. 7A and 7B shows the projected energy and power densities of a supercapacitor having porous graphene-MnO₂ nanocomposite electrodes, compared with present supercapacitors and lithium-ion batteries;

FIG. 8 shows the amount of graphene and MnO₂ in a kilogram nanocomposite material where 10 nm and 70 nm MnO₂ are coated on graphene surface for case I and II, respectively; and

FIG. 9 is a schematic showing component arrangement in a supercapacitor featuring nanocomposite electrodes.

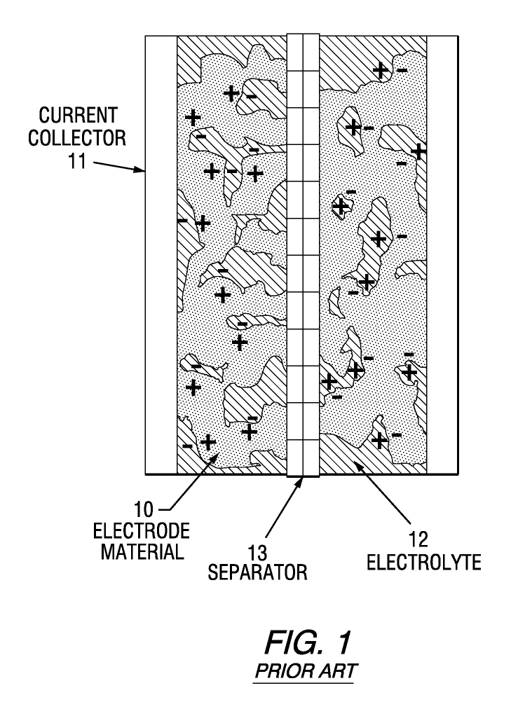

### DESCRIPTION OF THE PREFERRED EMBODIMENTS

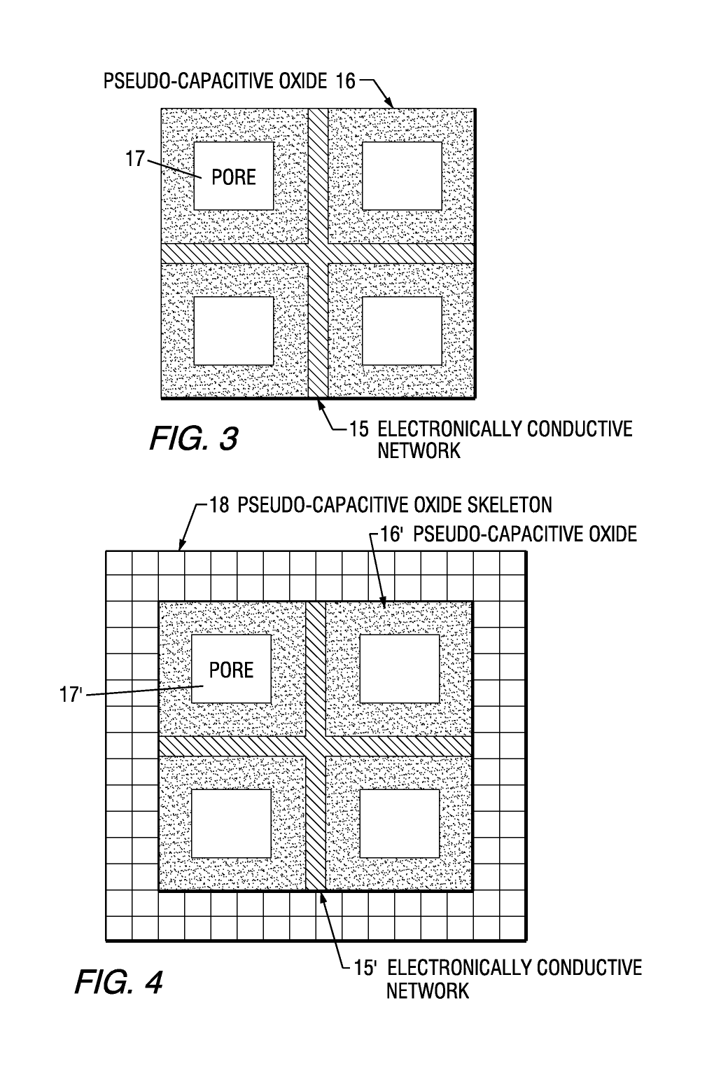

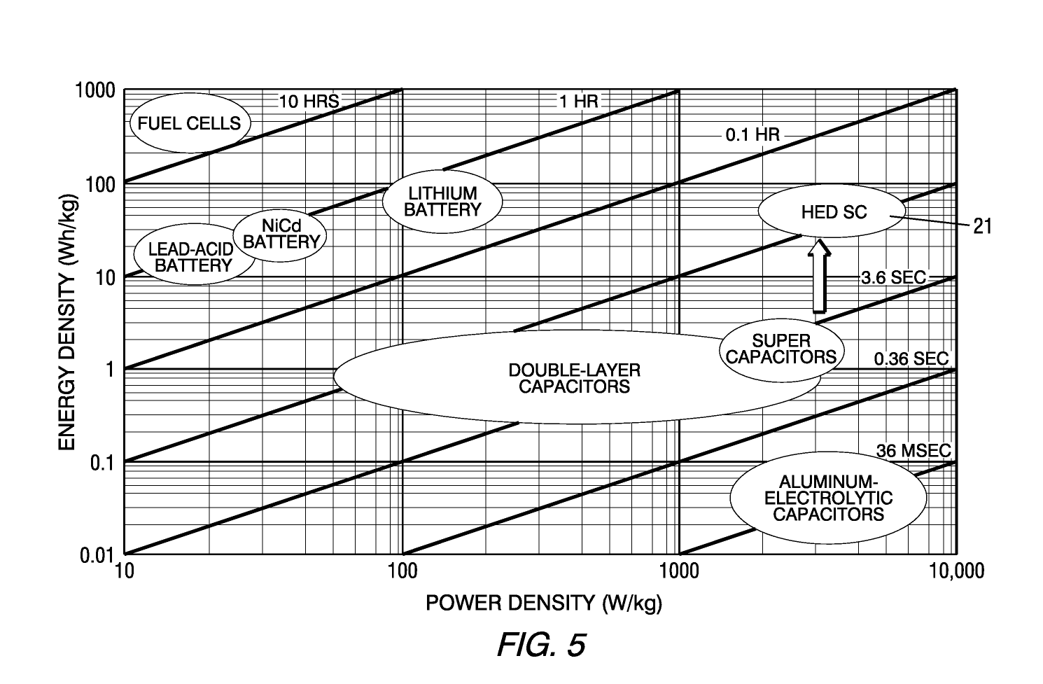

The invention describes a designed nanocomposite used as electrodes in a supercapacitor for increasing its energy density. As schematically shown in FIG. 3, a pseudo-capacitive oxide 16, whose practical application is hindered by its limited electrical conductivity, is supported by an electrically conductive network 15. Pores are shown as 17. On the other hand, as shown in FIG. 4, the nanocomposite can be produced by “decorating” the pores of a pseudo-capacitive skeleton 18 with carbon as the electrically conductive network 15′. Its surface area can be further increased by coating the carbon conductive network with the same or different pseudo-capacitive oxides 16′. Useful pseudo-capacitive oxides, 16 in FIGS. 3 and 16′ in FIG. 4, are selected from the group consisting of NiO, RuO₂, SrO₂, SrRuO₃, MnO₂ and mixtures thereof. Most preferably, NiO and MnO₂. Useful carbons are selected from the group consisting of activated carbon, amorphous carbon, carbon nanotubes and graphene, most preferably, activated carbon and graphene. Pores are shown as 17′. In the formed nanocomposites, the carbon network conducts electrons while the pseudo-capacitive oxide(s) take(s) part into charge-storage through both physical surface adsorption and chemical bulk absorption. As a consequence, a supercapacitor having electrodes made from the nanocomposite shows high energy density as shown as 21 HED SC (high energy density superconductor) in self-explanatory FIG. 5.

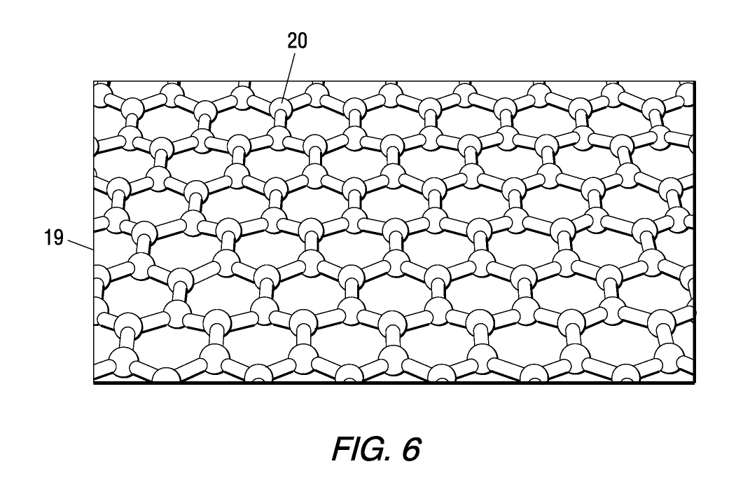

FIG. 6 illustrates an idealized planar sheet 50 of one-atom-thick graphine where carbon atoms C 51 are densely packed in a honeycomb crystal lattice as shown, having a surface area of 2,630 m²/g. Therefore, the graphene carbon supplies enormous amount of surface supporting pseudo-capacitive oxides.

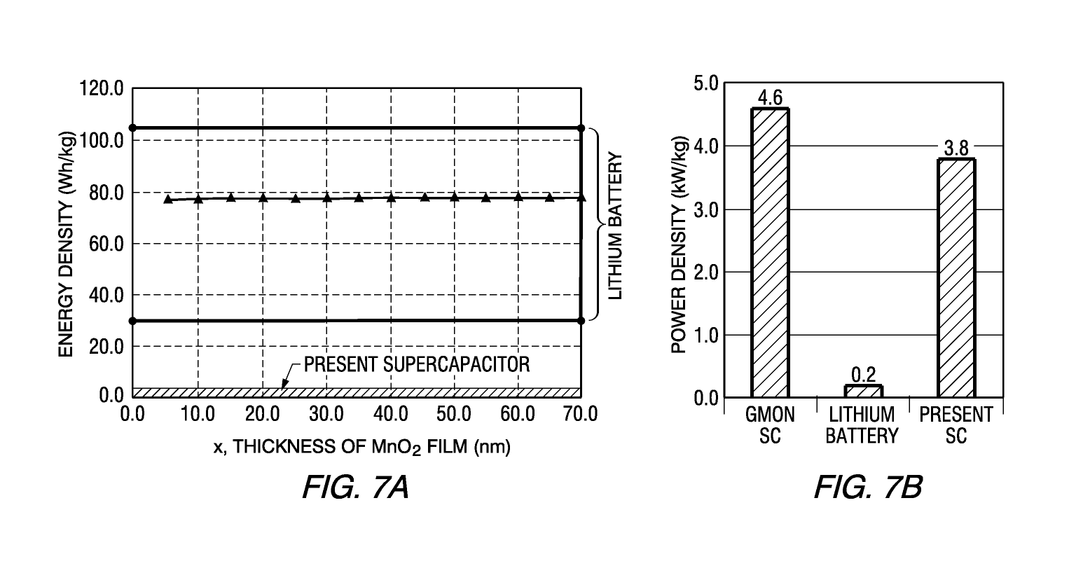

FIGS. 7A and 7B illustrates calculated energy and power density of a graphine/manganese oxide nanocomposite (“GMON”) utilized in supercapacitor mode. It is assumed that 1) working voltage of 0.8V; 2) MnO₂ capacitance is about 698 F/g; 3) MnO₂ fully contributes toward energy storage; 4) there are rapid kinetics; and 5) charge/discharge is in 60 seconds. It generally shows that while maintaining a high power density edge, the energy density of a GMON nanocomposite supercapacitor would be comparable to a lithium battery.

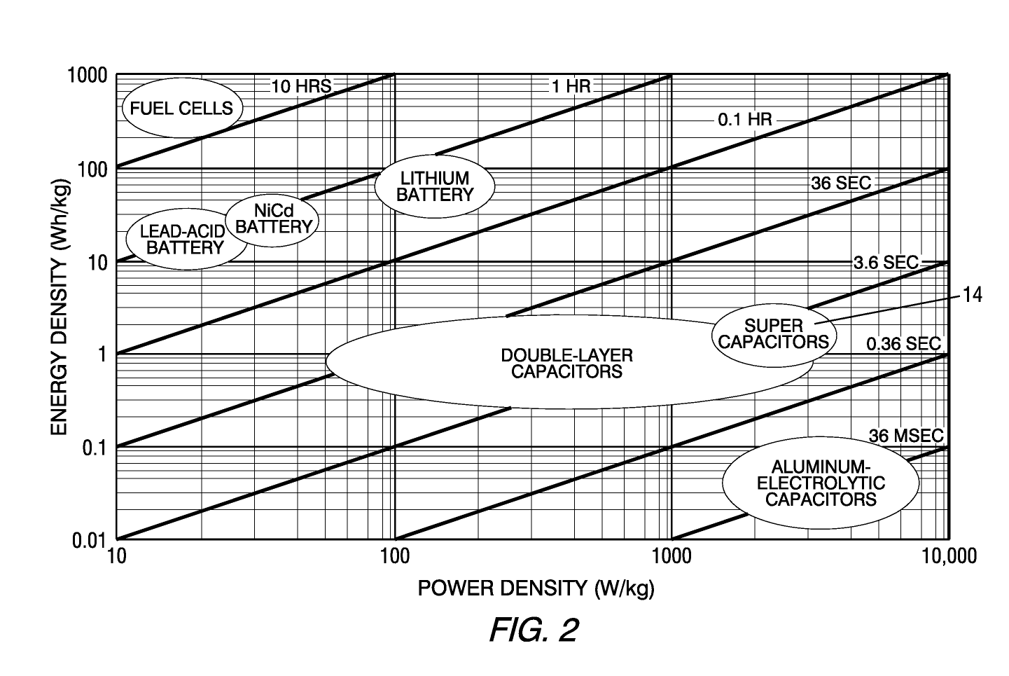

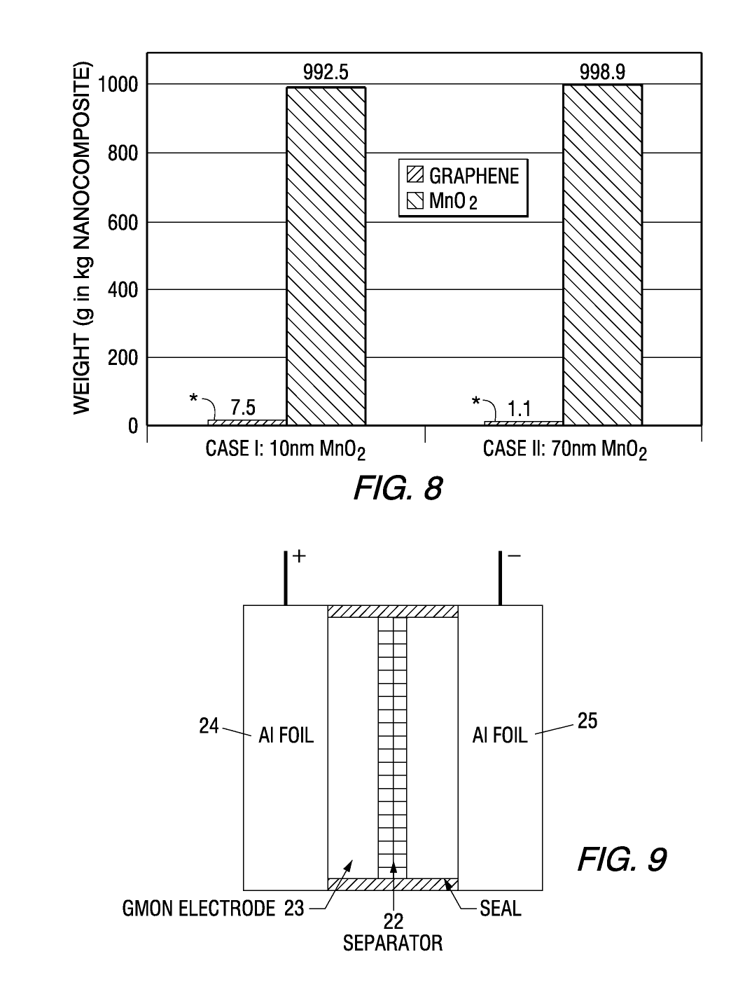

FIG. 8 shows the amount of graphene and MnO₂ in a kilogram nanocomposite material where 10 nm and 70 nm MnO₂ are coated on graphene surface for case I and II, respectively. In case I, graphene content 70 (g in one kg nanocomposite) is 7.5 to 992.5 MnO₂ shown as 71 and in case II, graphene content is only 1.1 to 998.9 MnO₂ illustrating the minimalist amount of graphene skeleton, which is much less than appears graphically in FIG. 2 and FIG. 3. FIG. 9 illustrates a conceptual single-cell design of central separator 22 having a nanocomposite electrode 23 soaked with electrolyte on each side, all with positive and negative outside metallic foils 24 and 25, such as aluminum; with the following specifications:

Voltage: 0.8V

Estimated volume: 18.5 cm×18.5 cm×0.21 cm
Electrode size 18 cm by 18 cm
Electrode thickness 1 mm
Total thickness of single cell 2.1 mm (plate, separator and current collector)

Charge/discharge time: 60 seconds

Power: 0.725 W

Energy capacity: 12 Wh

Weight: ˜174 g

While specific embodiments of the invention have been described in detail, it will be appreciated by those skilled in the art that various modifications and alternatives to those details could be developed in light of the overall teachings of the disclosure. Accordingly, the particular embodiments disclosed are meant to be illustrative only and not limiting as to the scope of the invention which is to be given the full breadth of the appended claims and any and all equivalents thereof.

What is claimed is:

1. An electrochemical energy storage device comprising a porous nanocomposite electrode comprising:
1) a porous electrically conductive carbon network having a surface area greater than 2,000 m²/g, and
2) a pseudo capacitive metal oxide, selected from the group consisting of NiO, RuO₂, SrO₂, SrRuO₃ and MnO₂, supported by the carbon network, wherein the network and oxide form a porous nanocomposite electrode.

2. The storage device of claim 1, also containing a pseudo-capacitive metal oxide skeleton, selected from the group consisting of NiO, RuO₂, SrO₂, SrRuO₃ and MnO₂, whose pores are continuously decorated by the carbon network and supported metal oxide, wherein the skeleton, carbon network and supported oxide form a porous nanocomposite electrode.

3. The storage device of claim 1, wherein the carbon network is graphene carbon.

4. The storage device of claim 1, wherein the pseudo-capacitive metal oxide is selected from the group consisting of NiO and MnO₂.

5. The storage device of claim 1, wherein two nanocomposite electrodes are disposed on either side of a separator and each electrode contacts a current collector.

6. The storage device of claim 3, wherein the graphene carbon has a surface area greater than from 2,000 m²/g.

7. The storage device of claim 3, wherein the graphene carbon has a surface area from 2,000 m²/g to 3,000 m²/g.

8. The storage device of claim 1, wherein the pseudo-capacitive metal oxide in component 2) is MnO₂.

9. The storage device of claim 1, wherein the electrode porosity is from 30 vol. % to 65 vol. % porous.

10. The storage device of claim 1, wherein the device is capable of storing energy both physically and chemically.
